(19) United States
(12) Patent Application Publication
(10) Pub. No.: US 2025/0014440 A1
(43) Pub. Date: Jan. 9, 2025

(54) TRANSMISSION OF DATA TO FIRE DEVICES OF A FIRE SYSTEM

(71) Applicant: Honeywell International Inc., Charlotte, NC (US)

(72) Inventors: Vimal Gracian, Trivandrum (IN); Thomas Steen Halkier, Copenhagen (DK); Jesper Bundgaard Sørensen, Copenhagen (DK)

(21) Appl. No.: 18/218,773

(22) Filed: Jul. 6, 2023

(51) Int. Cl. G08B 17/00; G08B 27/00

(52) U.S. Cl. CPC G08B 17/00; G08B 27/00

(57) ABSTRACT

Devices, systems, and methods for transmission of data to fire devices of a fire system are described herein. In some examples, one or more embodiments include a gateway device comprising a memory and a processor to execute instructions stored in the memory to receive an activation signal from a fire control panel, and transmit the activation signal to a plurality of fire devices included in a cluster according to predetermined time slots over a plurality of channels, where the plurality of fire devices are arranged in a bi-directional loop such that the activation signal is sent in a first direction around the bi-directional loop and in a second direction around the bi-directional loop simultaneously, and the first direction is opposite the second direction.

### TECHNICAL FIELD

The present disclosure relates to devices, systems, and methods for transmission of data to fire devices of a fire system.

### BACKGROUND

Facilities, such as commercial facilities, office buildings, hospitals, campuses (e.g., including buildings and outdoor spaces), and the like, may have an alarm system that can be triggered during an event, such as an emergency situation (e.g., a fire) to warn occupants to evacuate. Such an alarm system may include a fire system having a fire panel (e.g., a fire control panel) and a number of fire devices (e.g., sensors, sounders, pull stations, etc.) located throughout the facility (e.g., on different floors and/or in different rooms of the facility) that can perform an action when a hazard event is occurring in the facility and provide a notification of the hazard event to the occupants of the facility via alarms and/or other mechanisms.

### BRIEF DESCRIPTION OF THE DRAWINGS

FIG. 1 is an example of a fire system for transmission of data to fire devices of a fire system, in accordance with one or more embodiments of the present disclosure.

FIG. 2 is an example of a cluster arranged in a bi-directional loop for transmission of data to fire devices of a fire system, in accordance with one or more embodiments of the present disclosure.

FIG. 3 is an example of a timeslot and channel table for transmission of data to fire devices of a fire system, in accordance with one or more embodiments of the present disclosure.

FIG. 4 is an example of a gateway device for transmission of data to fire devices of a fire system, in accordance with one or more embodiments of the present disclosure.

### DETAILED DESCRIPTION

Devices, systems, and methods for transmission of data to fire devices of a fire system are described herein. In some examples, one or more embodiments include a gateway device comprising a memory and a processor to execute instructions stored in the memory to receive an activation signal from a fire control panel, and transmit the activation signal to a plurality of fire devices included in a cluster according to predetermined time slots over a plurality of channels, where the plurality of fire devices are arranged in a bi-directional loop such that the activation signal is sent in a first direction around the bi-directional loop and in a second direction around the bi-directional loop simultaneously, and the first direction is opposite the second direction.

A facility can utilize a fire system in order to warn occupants of the facility of an emergency event, such as a fire. As used herein, the term “fire system” refers to a system of devices to provide an audible and/or visible warning in an emergency event. For example, the fire system can utilize fire devices to warn occupants of the emergency event occurring in the space, such as a fire. As used herein, the term “fire device” refers to a device that can receive an input relating to an event and/or generate an output relating to an event. Such fire devices can be a part of the fire system of a space in a facility/in the facility at large and can include devices such as fire sensors, smoke detectors, heat detectors, carbon monoxide (CO) detectors, or combinations of these; interfaces; manual call points (MCPs); pull stations; input/output modules; aspirating units; and/or audio/visual devices (e.g., speakers, sounders, flashers, buzzers, microphones, cameras, video displays, video screens, etc.), relay output modules, among other types of fire devices.

A fire system can transmit data from a control panel to fire devices through a gateway device. Latency may be an issue when such information is transmitted between devices. Latency can be a time delay between transmission of data occurring following an instruction for its transmission.

Fire systems may be deemed to meet certain design requirements defined by various governing standards and/or protocols. Such standards/protocols may be defined based on a jurisdiction in which the fire system is located. One example of such a standard/protocol can be the Underwriters' Laboratories (UL) standards, such as UL Standard 864. One example of a standard/protocol may be a requirement of a 10 second latency for alarm transmissions. In such an example, the standard/protocol may require a fire system to transmit information throughout the fire system in order to activate a fire device within 10 seconds from the time which an emergency event (e.g., a fire) is detected. For example, when a fire is detected (e.g., via a detector of a fire device, via an input to a pull station, etc.), the standard can dictate that a fire device (or some or all of the fire devices in the fire system) must be activated within 10 seconds of the fire being detected. That is, transmission of data from a fire device to a fire control panel (e.g., via a gateway device and/or other fire devices) and vice versa has to be completed within 10 seconds, as per the latency requirement in the standard/protocol.

Certain fire systems may include many fire devices. In some examples, such fire systems may utilize a distributed wireless mesh to connect fire devices with gateway devices and to the fire control panel.

Transmission of data to fire devices of a fire system according to the disclosure can allow for fire devices of a fire system to be arranged in such a way so as to meet certain latency requirements for transmission of data within the fire system. Such an approach can allow for protocols/standards to be met while also providing for fire device synchronization and better fire device redundancy, gateway device redundancy, and communication channel redundancy, as compared with previous approaches.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

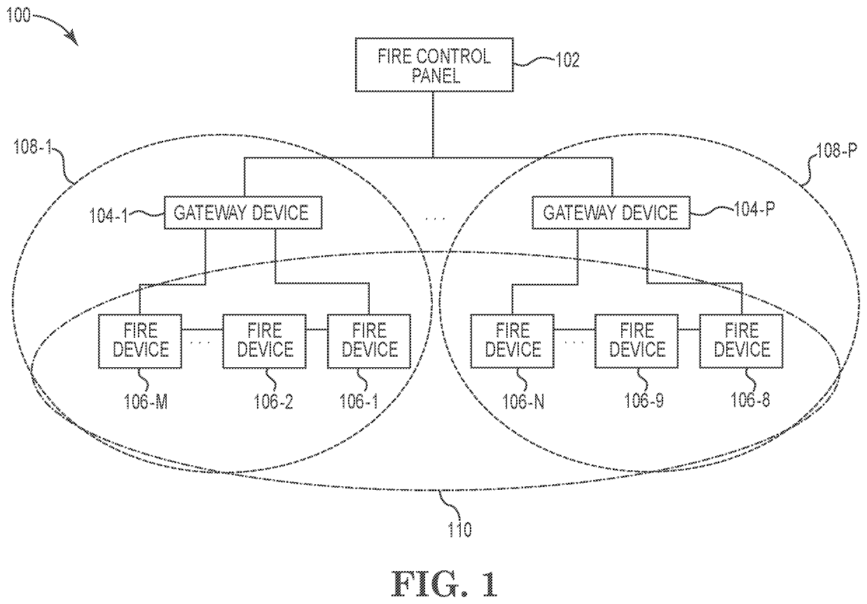

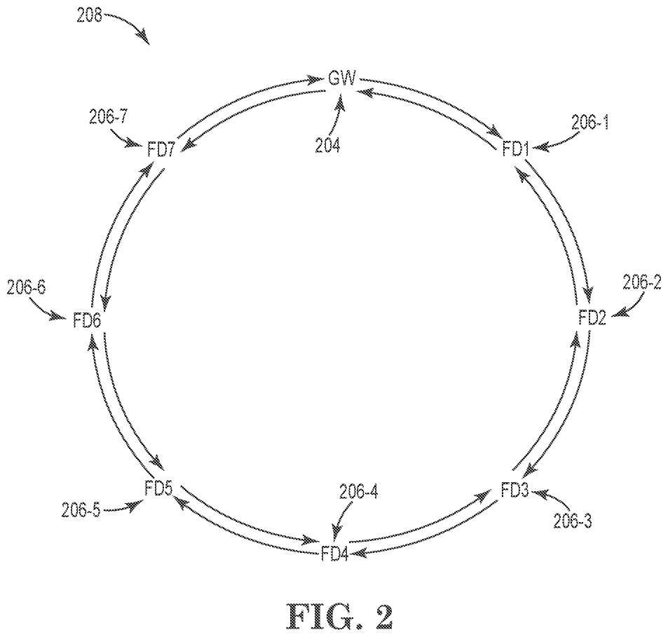

The figures herein follow a numbering convention in which the first digit or digits correspond to the drawing figure number and the remaining digits identify an element or component in the drawing. Similar elements or components between different figures may be identified by the use of similar digits. For example, 104 may reference element “04” in FIG. 1, and a similar element may be referenced as 204 in FIG. 2.

As used herein, “a”, “an”, or “a number of” something can refer to one or more such things, while “a plurality of” something can refer to more than one such things. For example, “a number of components” can refer to one or more components, while “a plurality of components” can refer to more than one component.

FIG. 1 is an example of a fire system 100 for transmission of data to fire devices 104 of a fire system 100, in accordance with one or more embodiments of the present disclosure. The fire system 100 can include a fire control panel 102, gateway devices 104-1, 104-P, and fire devices 106-1, 106-2, 106-M, 106-8, 106-9, 106-N.

As mentioned above, the fire system 100 can be included in a facility, a space in a facility, etc. The fire system 100 can include a device/series of devices in order to detect events and/or process and/or analyze the detected events to determine whether to generate an alarm for occupants of the facility.

The fire system 100 can include fire devices 106-1, 106-2, 106-M, 106-8, 106-9, 106-N (referred to collectively as fire devices 106). The fire devices 106 can be devices to detect an event and transmit the detected event for processing and/or analysis. As mentioned above, the fire devices 106 can include, for example, cameras, motion sensors, fire sensors, smoke detectors, heat detectors, carbon monoxide (CO) detectors, or combinations of these; interfaces; manual call points (MCPs); pull stations; input/output modules; aspirating units; sprinkler controls; and/or audio/visual devices (e.g., speakers, microphones, cameras, video displays, video screens, etc.), relay output modules, among other types of event devices.

The fire system 100 can further include a fire control panel 102. The fire control panel 102 can be utilized to control the various fire devices 106 included in the fire system 100.

The fire control panel 102 can be connected to the fire devices 106. For example, the fire control panel 102 may be connected to the fire devices 106 via gateway devices 104-1, 104-P (referred to collectively as gateway devices 104). The gateway devices 104 can be devices (e.g., a building system gateway) that provides a communication link between the fire control panel 102 and fire devices 106, as well as any peripheral devices that may be included in the fire system 100 (e.g., not illustrated in FIG. 1). For example, the gateway devices 104 can enable transmission of data (e.g., fire system device data, activation signals, etc.) from the fire control panel 102 to the fire devices 106 and transmission of data from the fire devices 106 to the fire control panel 102.

As illustrated in FIG. 1, the fire devices 106 and gateway devices 104 can be connected to the fire control panel 102. The fire devices 106 and gateway devices 104 can be connected to the fire control panel 102 via a wireless network relationship. Examples of such a network relationship can include a local area network (LAN), wide area network (WAN), personal area network (PAN), a distributed computing environment (e.g., a cloud computing environment), storage area network (SAN), Metropolitan area network (MAN), a cellular communications network, Long Term Evolution (LTE), visible light communication (VLC), Bluetooth, Worldwide Interoperability for Microwave Access (WiMAX), Near Field Communication (NFC), infrared (IR) communication, Public Switched Telephone Network (PSTN), radio waves, and/or the Internet, among other types of network relationships.

As mentioned above, in some examples, at least the fire devices 106 and gateway devices 104 can be connected via a distributed wireless mesh. The fire devices 106 can be arranged in a mesh 110. Further, the gateway devices 104 and fire devices 106 can be arranged in clusters 108. For example, gateway device 104-1 can be connected to fire devices 106-1, 106-2, and 106-M and be arranged in a cluster 108-1, and gateway device 104-P can be connected to fire device 106-8, 106-9, 106-N and be arranged in a cluster 108-P, etc. Further, the fire devices 106-1, 106-2, 106-M, 106-8, 106-9, 106-N can be connected in a mesh 110. Such an arrangement of devices can allow for transmission of data to fire devices within the fire system 100 that meets latency requirements for various standards/protocols, as is further described herein. Additionally, when such a fire system 100 is created, the clusters 108-1, 108-P and mesh 110 can be generated, as is further described herein.

When the fire devices 106 are powered on, each of the fire devices 106 can connect to a neighboring fire device 106. For example, fire device 106-1 can connect to neighboring fire device 106-2, etc. Such connections can be made via predetermined mesh identifiers included in each fire device 106 of the fire devices 106. For example, fire device 106-1 can include a predetermined mesh identifier including a unique profile having a unique identifier (e.g., internet protocol (IP) address, Media Access Control (MAC) address, etc.) and network keys. Fire device 106-2 can include similar predetermined mesh identifier information that is unique to fire device 106-2, etc. Each fire device 106 of the fire devices 106 can connect to neighboring fire devices 106 when the fire devices 106 are powered on. Accordingly, each of the fire devices 106 can connect to neighboring fire devices 106 in response to being powered on via the predetermined mesh identifiers included in each of the fire devices 106 to generate the mesh 110.

As is further described herein, a gateway device 104 can generate a cluster 108. While the example described below illustrates generation of the cluster 108-1 via gateway device 104-1, the gateway device 104-P can generate cluster 108-P in a similar manner.

The gateway device 104-1 can generate the cluster 108-1 by receiving signal strengths of neighboring fire devices 106 for each fire device of the plurality of fire devices 106. For example, the fire device 106-1 can transmit a signal strength with the fire device 106-2 to the gateway device 104-1, the fire device 106-2 can transmit a signal strength with fire devices 106-1 and 106-M to gateway device 104-1, fire device 106-M can transmit a signal strength with fire device 106-2 to the gateway device 104-1, etc. Such signal strength can be, for example, Received Signal Strength Indicator (RSSI) values. Such information can be transmitted to the gateway device 104-1 in response to receiving (e.g., by each fire device 106-1, 106-2, 106-M) a signal strength query from the gateway device 104-1. Each fire device 106-1, 106-2, 106-M can align to the cluster 108-1 via a predetermined network key included in each fire device 106-1, 106-2, 106-M.

Once the gateway device 104-1 includes signal strength information of the neighboring fire devices for each fire device 106-1, 106-2, 106-M of the fire devices 106, the gateway device 104-1 can determine a best possible neighbor for each fire device 106-1, 106-2, 106-M of the fire devices 106 based on the signal strengths. In order to determine the best possible neighbor for each fire device 106-1, 106-2, 106-M of the fire devices 106, the gateway device 104-1 can determine a suboptimal shortest path through the fire devices 106-1, 106-2, 106-M in the cluster 108-1 via simulated annealing. Simulated annealing can include a probabilistic technique for approximating a global optimum of a given function for an optimization problem. The gateway device 104-1 can utilize the signal strengths of the neighboring fire devices 106 for each fire device 106-1, 106-2, 106-M to find the best possible neighbor for each fire device 106-1, 106-2, 106-M via the simulated annealing algorithm.

The suboptimal shortest path through the fire devices 106-1, 106-2, 106-M determined via simulated annealing can be a Hamiltonian path. The Hamiltonian path (e.g., a traceable path) can be a path through a graph of nodes which visits each node exactly once. Such a path can be generated that defines a bi-directional loop of fire devices 106 in the cluster 108-1. For instance, in the example illustrated in FIG. 1, the cluster 108-1 can include a bi-directional loop of fire devices 106 that is organized such that the gateway device 104-1 is located one space to the right (e.g., counterclockwise (CCW) from fire device 106-1), fire device 106-2 is located to the right (e.g., CCW) from fire devices 106-1, and fire device 106-M is located to the right (e.g., CCW) from fire device 106-2 and to the left (e.g., CW) from gateway device 104-1. Such a bi-directional loop is further illustrated and described in connection with FIG. 2.

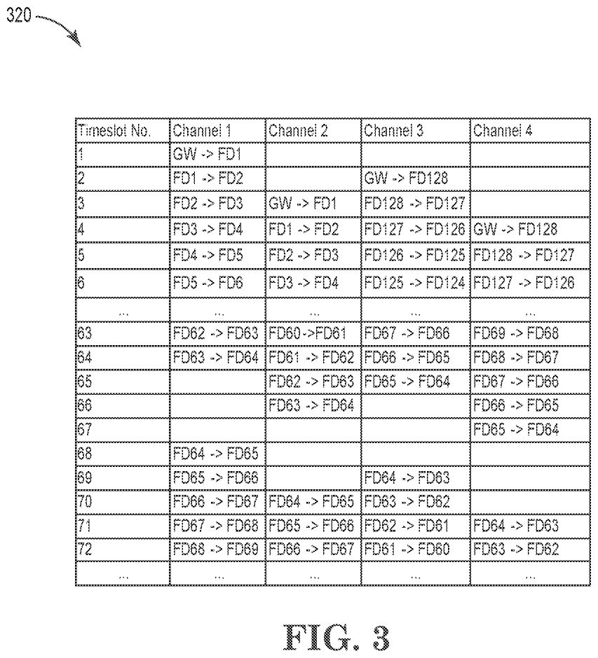

Once the bi-directional loop is generated, the gateway device 104-1 can allocate predetermined timeslots over a various channels for each fire device 106-1, 106-2, 106-M based on a position of the gateway device 104-1 with respect to the bi-directional loop. For example, the gateway device 104-1 can get the first time slot, fire device 106-1 can get the second time slot, fire device 106-2 can get the third time slot, and fire device 106-M can get the “M'th” time slot. Additionally, each fire device 106-1, 106-2, 106-M can utilize four communication channels for transmission of data through the bi-directional loop of the cluster 108-1 so that each fire device 106-1, 106-2, 106-M can make four consecutive transmissions over four allocated channels, as is further described in connection with FIG. 3.

While the clusters 108-1 and 108-P are illustrated in FIG. 1 as including three fire devices 106-1, 106-2, 106-M and 106-8, 106-9, 106-N, respectively, embodiments of the present disclosure are not so limited. For example, clusters 108-1 and 108-P may include more than three fire devices 106 or less than three fire devices 106. Further, cluster 108-1 may include the same amount of fire devices 106 as cluster 108-P or a different amount of fire devices 106 than cluster 108-P (e.g., more or less). Moreover, while the fire system 100 illustrates two clusters 108-1, 108-P, embodiments of the present disclosure are not so limited. For example, the fire system 100 can include more than two clusters 108.

With the clusters 108-1, 108-P, and the mesh 110 generated, the fire system 100 can transmit data. Such data can be transmitted from the fire devices 106 to the fire control panel 102 via the gateway devices 104 and vice versa, as is further described herein.

During operation of the fire system 100, the gateway device 104-1 can be polling each of the fire devices 106-1, 106-2, 106-M of the cluster 108-1 for fire activation data (e.g., detection of an event in the facility, such as smoke detection, heat detection, pull station activation, etc. by the fire devices 106-1, 106-2, 106-M) in two directions simultaneously (e.g., both CW and CCW around the bi-directional loop of fire devices 106-1, 106-2, 106-M). Each direction can be polled twice on two separate channels. Such a polling process is further described herein with respect to transmission of activation data from the fire control panel 102 to the fire devices 106, but the process works similar for transmission of fire activation data transmitted from the fire devices 106 to the fire control panel 102. Additionally, while the example described herein relates to operation of the gateway device 104-1 within the cluster 108-1, the gateway device 104-P within the cluster 108-P can operate in a similar manner.

As mentioned above, when an event is detected in the facility, the fire control panel 102 can determine whether to activate a fire device 106 in the fire system 100. For example, the fire control panel 102 can receive fire activation data from a fire device 106 (e.g., via a gateway device 104), such as a signal from a pull station, smoke data, heat data, etc. Based on the received activation data, the fire control panel 102 can determine whether a fire event is occurring from the fire device activation data. In response to the fire control panel 102 determining a fire event is occurring from the fire device activation data, the fire control panel 102 can transmit an activation signal to the fire devices 106, as is further described herein.

As previously mentioned above, the fire devices 106-1, 106-2, 106-M can be arranged in a bi-directional loop within the cluster 108-1. Upon determination by the fire control panel 102 that an event is occurring in the facility, the fire control panel 102 can transmit an activation signal to the gateway device 104-1. The gateway device 104-1 can receive the activation signal from the fire control panel 102 and transmit the activation signal to the fire devices 106-1, 106-2, 106-M via the bi-directional loop, as is further described herein.

For example, the gateway device 104-1 can transmit the activation signal in a first direction (e.g., CW) around the bi-directional loop by transmitting the activation signal to the fire device 106-1; the fire device 106-1 can then transmit the activation signal to the fire device 106-2, and finally the fire device 106-2 can transmit the activation signal to the fire device 106-M. Simultaneously, the gateway device 104-1 can transmit the activation signal in a second direction (e.g., CCW) that is opposite the first direction around the bi-directional loop by transmitting the activation signal to the fire device 106-M; the fire device 106-M can then transmit the activation signal to the fire device 106-2, and finally the fire device 106-2 can transmit the activation signal to the fire device 106-1. Such transmissions can occur over sets of predetermined time slots over a plurality of channels, as is further described in connection with FIG. 3.

Since the gateway device 104-1 transmits the activation signal simultaneously around the bi-directional loop in opposite directions, if a fire device 106 is not operational, such an activation signal can still reach other fire devices in the bi-directional loop. For example, if fire device 106-2 experiences a problem and is not operational, the activation signal sent CW around the bi-directional loop can reach fire device 106-1 but not fire device 106-M. However, the activation signal sent CCW around the bi-directional loop can reach fire device 106-M. Accordingly, such an approach can provide for fire device redundancy to ensure signals are sent to and/or received from fire devices in the bi-directional loop, even if a fire device is not active.

As illustrated in FIG. 1, each gateway device 104 includes a bi-directional loop in each respective cluster 108. Each gateway device 104 can include a loop timing amount to complete a transmission around the fire devices 106 in the bi-directional loop. For example, gateway device 104-1 can include a 250 millisecond (ms) interval to complete transmission of information around the bi-directional loop of fire devices 106-1, 106-2, 106-M at four transmissions per device in four different channels. The gateway devices 104-1, 104-P can be aligned in a global timing scheme. For example, the first gateway device 104-1 can transmit the activation signal to the fire devices 106-1, 106-, 106-M at a first predetermined time, and the second gateway device 104-P can transmit the activation signal to the fire devices 106-8, 106-9, 106-N at a second predetermined time that is after the first predetermined time. For example, the gateway device 104-P can transmit the activation signal to the fire devices 106-8, 106-9, 106-N 250 ms after the gateway device 104-1 transmits the activation signal to the fire devices 106-1, 106-2, 106-M. In other words, the transmission of signals to and/or from the bi-directional loops can be staggered.

Upon receiving an activation signal, a fire device 106 of the fire devices can activate itself. For example, fire devices 106-1, 106-2, 106-M may activate in response to receiving the activation signal. Activation of the fire devices 106 may include activating a visual alarm (e.g., emitting lights) and/or an audible alarm (e.g., emitting an audible sound).

Within the mesh 110, a fire device of the fire devices 106 can be a synchronization fire device. For example, the fire device 106-8 can be a synchronization fire device in order to synchronize alarm emissions. The synchronization fire device can include synchronization information including a synchronization start time, an amount of hops across the mesh of fire devices 106 (e.g., the number of nodes within the mesh 110/the total number of fire devices 106 within the mesh 110), and a predetermined drift amount (e.g., clock drift). The fire device 106-8 can synchronize the remaining fire devices 106 in the mesh 110 by transmitting the synchronization information to each of the fire devices 106. For example, the fire device 106-8 can determine that if there are ten fire devices 106 at 30.5 microseconds drift per device, based on a distribution of the drift, an average synchronization amount of 3.5 ms can be transmitted to each of the fire devices 106 for synchronization.

As mentioned above, while transmission of an activation signal to the fire devices 106 from the fire control panel 102 is described above, the same process can be utilized to poll each of the fire devices 106 for fire activation data for transmission to the fire control panel 102. Transmission of such information around a bi-directional loop is further described in connection with FIG. 2.

FIG. 2 is an example of a cluster 208 arranged in a bi-directional loop for transmission of data to fire devices 206 of a fire system, in accordance with one or more embodiments of the present disclosure. The bi-directional loop can include a loop of fire devices 206-1, 206-2, 206-3, 206-4, 206-5, 206-6, 206-7, and a gateway device 204.

As illustrated in FIG. 2, the fire devices 206 can be arranged in a bi-directional loop such that the form a traceable path. Such a traceable path can be a Hamiltonian path, as previously described in connection with FIG. 1.

The gateway device 204 can poll information from (e.g., fire activation data) and/or transmit information to (e.g., an activation signal) the fire devices 206 in multiple directions simultaneously. For example, the gateway device can transmit an activation signal to the fire devices 206 by transmitting the activation signal to fire device 206-1 in a first direction (e.g., CW) and to fire device 206-7 in a second direction (e.g., CCW).

Transmitting the activation signal to the fire device 206-1 in the first direction causes the fire device 206-1 to transmit the activation signal to the fire device 206-2. Continuing with this direction, transmitting the activation signal to the fire device 206-2 in the first direction causes the fire device 206-2 to transmit the activation signal to the fire device 206-3, the activation signal to the fire device 206-3 in the first direction causes the fire device 206-3 to transmit the activation signal to the fire device 206-4, the activation signal to the fire device 206-4 in the first direction causes the fire device 206-4 to transmit the activation signal to the fire device 206-5, the activation signal to the fire device 206-5 in the first direction causes the fire device 206-5 to transmit the activation signal to the fire device 206-6, and lastly, the activation signal to the fire device 206-6 in the first direction causes the fire device 206-6 to transmit the activation signal to the fire device 206-7.

Similarly, transmitting the activation signal to the fire device 206-7 in the second direction causes the fire device 206-7 to transmit the activation signal to the fire device 206-6. Continuing with this direction, transmitting the activation signal to the fire device 206-6 in the second direction causes the fire device 206-6 to transmit the activation signal to the fire device 206-5, the activation signal to the fire device 206-5 in the second direction causes the fire device 206-5 to transmit the activation signal to the fire device 206-4, the activation signal to the fire device 206-4 in the second direction causes the fire device 206-4 to transmit the activation signal to the fire device 206-3, the activation signal to the fire device 206-3 in the second direction causes the fire device 206-3 to transmit the activation signal to the fire device 206-2, and lastly, the activation signal to the fire device 206-2 in the second direction causes the fire device 206-2 to transmit the activation signal to the fire device 206-1.

As mentioned above, the signal can be sent four times around the bi-directional loop in multiple channels. Such an approach can prevent interference from preventing signals from transiting all the way through the bi-directional loop, as is further described in connection with FIG. 3.

FIG. 3 is an example of a timeslot and channel table 320 for transmission of data to fire devices of a fire system, in accordance with one or more embodiments of the present disclosure. The timeslot and channel table 320 may be utilized to poll information from (e.g., fire activation data) and/or transmit information to (e.g., an activation signal) fire devices in multiple directions simultaneously around a bi-directional loop.

Each fire device can include transmit and receive timeslots allocated according to the timeslot and channel table 320. As illustrated in the timeslot and channel table 320, the bi-directional loop can include 128 fire devices. While the timeslot and channel table 320 is illustrated as including 72 timeslots, based on the 128 fire devices, the timeslot and channel table 320 can include 134 timeslots to allow for polling and transmission of data for each of the 128 fire devices, as is further described herein.

As previously mentioned above, polling and/or transmission of data can be performed at four transmissions per device in four different channels. For example, an activation signal can transmitted in a staggered manner of the four channels by transmitting a first activation signal in a first direction over a first channel (channel 1) at a first timeslot (timeslot 1). For instance, the gateway device (e.g., GW as illustrated in the timeslot and channel table 320) can transmit the activation signal to the first fire device (e.g., FD1 as illustrated in the timeslot and channel table 320) in the first channel in the first timeslot. At timeslot 2, FD1 can transmit the activation signal in the first direction to FD2 in channel 1, and GW can transmit the activation signal in the second direction to FD1 in channel 3. No transmissions may occur in channels 2-4 in timeslot 1 or in channels 2 and 4 in timeslot 2. At timeslot 3, FD2 can transmit the activation signal in the first direction to FD3 in channel 1, GW can transmit the activation signal in the first direction to FD1 in channel 2, and FD 128 can transmit the activation signal in the second direction to FD127 in the second direction in channel 3. At timeslot 4, FD3 can transmit the activation signal in the first direction to FD4 in channel 1, FD1 can transmit the activation signal in the first direction to FD2 in channel 2, FD127 can transmit the activation signal in the second direction to FD126 in channel 3, and GW can transmit the activation signal in the second direction to FD128 in channel 4.

Such a process can continue through all of the timeslots so that the loop is interrogated and/or data is transmitted through the loop in both directions (e.g., CW and CCW) simultaneously. For instance, each direction can be interrogated and/or transmit data twice on two separate channels. Such an approach can improve immunity to noise (e.g., single narrowband high-power blocking). For example, if another device may be transmitting data over a frequency that is close to channels 1, 2, 3, or 4, such transmission may result in noise affecting interrogation and/or transmission of data through the bi-directional loop. However, such an approach as described above can allow for interrogation and/or transmission of data to reach all of the fire devices in the bi-directional loop, as a failure of a fire device results in messages that can still be received who are prior to the failed fire device in the bi-directional loop. Further, interleaving can be done to avoid a single fire device having to transmit and receive at the same time.

As illustrated in the timeslot and channel table 320, four channels can be utilized that may be at different frequencies. For example, the first channel can be at a first frequency (e.g., 2412 Megahertz (MHZ)) and the third channel can be at a third frequency (e.g., 2417 MHz) that is proximate to the first frequency. Additionally, the second channel can be at a second frequency (e.g., 2462 MHZ) and the fourth channel can be at a fourth frequency (e.g., 2467 MHZ) that is proximate to the second frequency. The first frequency and third frequency can be spaced apart from the second frequency and fourth frequency in a frequency band. Spacing apart the frequencies in a particular frequency band can prevent another device outside of the fire system which may be transmitting from blocking all of the channels simultaneously.

The gateway device can further listen to time slots based on signal strengths of its available neighboring fire devices. The gateway can include primary receive slots of its immediate neighboring fire devices, but in addition, can listen to fire devices that are not primary neighbors but are within range of the neighboring fire devices. Such an approach can allow the gateway device redundancy. Further, each fire device has a listen slot of its immediate neighboring fire device, and in addition can listen to additional devices based on the neighboring fire device availability. The distribution of the listening slots can be such that the fire device can listen to two channels of a given fire device and an additional two channels of another fire device. Lastly, as mentioned above, the fire devices are allocated four channels for transmissions. These channels can be monitored for packet error rate (PER) at a particular frequency (e.g., every two seconds). If a channel PER exhibits a high rate of PER (e.g., exceeds a PER threshold), the fire devices can be switched to a redundant channel.

Accordingly, transmission of data to fire devices of a fire system according to the disclosure can allow for fire devices of a fire system to be arranged in such a way so as to meet latency requirements for transmission of data within the fire system while also providing for fire device synchronization and fire device redundancy in the case in which a fire device becomes inoperable. Further, such an approach can allow for gateway device redundancy and communication channel redundancy so that fire devices are reliably activated in the case of an emergency event in order to warn occupants of a facility of such an emergency event.

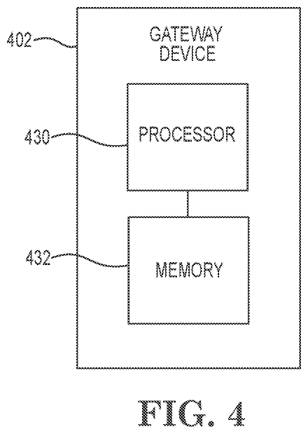

FIG. 4 is an example of a gateway device 402 for transmission of data to fire devices of a fire system, in accordance with one or more embodiments of the present disclosure. As illustrated in FIG. 4, the gateway device 402 can include a memory 432 and a processor 430 for transmission of data to fire devices of a fire system, in accordance with the present disclosure.

The memory 432 can be any type of storage medium that can be accessed by the processor 430 to perform various examples of the present disclosure. For example, the memory 432 can be a non-transitory computer readable medium having computer readable instructions (e.g., executable instructions/computer program instructions) stored thereon that are executable by the processor 430 for transmission of data to fire devices of a fire system in accordance with the present disclosure.

The memory 432 can be volatile or nonvolatile memory. The memory 432 can also be removable (e.g., portable) memory, or non-removable (e.g., internal) memory. For example, the memory 432 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 432 is illustrated as being located within gateway device 402, embodiments of the present disclosure are not so limited. For example, memory 432 can also be located internal to another computing resource (e.g., enabling computer readable instructions to be downloaded over the Internet or another wired or wireless connection).

The processor 430 may be a central processing unit (CPU), a semiconductor-based microprocessor, and/or other hardware devices suitable for retrieval and execution of machine-readable instructions stored in the memory 432.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A gateway device for transmission of data to fire devices of a fire system, comprising:
a memory; and
a processor configured to execute executable instructions stored in the memory to:
receive an activation signal from a fire control panel; and
transmit the activation signal to a plurality of fire devices included in a cluster according to predetermined time slots over a plurality of channels;
wherein:
the plurality of fire devices are arranged in a bi-directional loop such that the activation signal is sent in a first direction around the bi-directional loop and in a second direction around the bi-directional loop simultaneously; and
the first direction is opposite the second direction.

2. The gateway device of claim 1, wherein the processor is configured to stagger transmission of the activation signal over the plurality of channels by:
transmitting the activation signal in the first direction over a first channel at a first timeslot;
transmitting the activation signal in the second direction over a third channel at a second timeslot;
transmitting the activation signal in the first direction over a second channel at a third timeslot; and
transmitting the activation signal in the second direction over a fourth channel at a fourth timeslot.

3. The gateway device of claim 2, wherein:
the first channel is at a first frequency and the third channel is at a third frequency that is proximate to the first frequency; and
the second channel is at a second frequency and the fourth channel is at a fourth frequency that is proximate to the second frequency.

4. The gateway device of claim 3, wherein the first frequency and the third frequency are spaced apart from the second frequency and the fourth frequency in a frequency band.

5. The gateway device of claim 1, wherein the processor is configured to:
receive fire device activation data from a fire device of the plurality of fire devices;
transmit the fire device activation data to the fire control panel; and
receive the activation signal from the fire control panel in response to the fire control panel determining a fire event is occurring from the fire device activation data.

6. The gateway device of claim 1, wherein the processor is configured to cause at least one fire device of the plurality of fire devices to activate via the activation signal.

7. The gateway device of claim 1, wherein the processor is configured to transmit the activation signal to the plurality of fire devices by transmitting the activation signal to a first fire device of the plurality of fire devices in the first direction and a third fire device of the plurality of fire devices in the second direction.

8. The gateway device of claim 7, wherein:
transmitting the activation signal to the first fire device in the first direction causes the first fire device to transmit the activation signal to a second fire device of the plurality of fire devices and the second fire device to transmit the activation signal to the third fire device in the first direction around the bi-directional loop; and
transmitting the activation signal to the third fire device in the second direction causes the third fire device to transmit the activation signal to the second fire device and the second fire device to transmit the activation signal to the first fire device in the second direction around the bi-directional loop.

9. A fire system for transmission of data to fire devices, comprising:
a fire control panel;
a first cluster comprising:
a first plurality of fire devices arranged in a first bi-directional loop; and
a first gateway device to transmit an activation signal received from the fire control panel to the first plurality of fire devices in a first direction around the first bi-directional loop and a second direction around the first bi-directional loop simultaneously according to a first set of predetermined time slots over a plurality of channels; and
a second cluster comprising:
a second plurality of fire devices arranged in a second bi-directional loop; and
a second gateway device to transmit the activation signal received from the fire control panel to the second plurality of fire devices in a first direction around the second bi-directional loop and a second direction around the second bi-directional loop simultaneously according to a second set of predetermined time slots over the plurality of channels.

10. The system of claim 9, wherein the first gateway device is to transmit the activation signal to the first plurality of fire devices at a first predetermined time and the second gateway device is to transmit the activation signal to the second plurality of fire devices at a second predetermined time that is after the first predetermined time.

11. The system of claim 9, wherein:
the first plurality of fire devices are arranged in the first bi-directional loop such that they form a first traceable path; and
the second plurality of fire devices are arranged in the second bi-directional loop such that they form a second traceable path.

12. The system of claim 11, wherein the first traceable path and the second traceable path are Hamiltonian paths.

13. The system of claim 9, wherein the system further includes a mesh of fire devices comprising the first plurality of fire devices and the second plurality of fire devices.

14. The system of claim 13, wherein:
a fire device of the mesh of fire devices is a synchronization fire device; and
the synchronization fire device is configured to synchronize the mesh of fire devices according to:
a synchronization start time;
an amount of hops across the mesh of fire devices; and
a predetermined drift amount.

15. A method for transmission of data to fire devices of a fire system, comprising:
generating, by a gateway device, a cluster including a bi-directional loop of fire devices from a plurality of fire devices included in a mesh by:
receiving signal strengths of neighboring fire devices for each fire device of the plurality of fire devices;
determining a best possible neighbor for each fire device of the plurality of fire devices based on the signal strengths;
generating a path defining the bi-directional loop; and
allocating predetermined timeslots over a plurality of channels for each fire device of the plurality of fire devices based on a position of the gateway device with respect to the bi-directional loop;
receiving, by the gateway device from a fire control panel, an activation signal;
transmitting, by the gateway device, the activation signal to the plurality of fire devices in a first direction around the bi-directional loop and a second direction around the bi-directional loop simultaneously according to predetermined time slots over the plurality of channels; and
causing, by the activation signal, activation of at least one fire device of the plurality of fire devices.

16. The method of claim 15, wherein determining the best possible neighbor includes determining a suboptimal shortest path through the plurality of fire devices in the cluster via simulated annealing.

17. The method of claim 16, wherein the suboptimal shortest path is a Hamiltonian path defining the bi-directional loop.

18. The method of claim 15, wherein the method further includes generating the mesh by connecting, by each fire device of the plurality of fire devices, to a neighbor fire device in response to being powered on via predetermined mesh identifiers included in each fire device of the plurality of fire devices.

19. The method of claim 18, wherein generating the mesh further includes aligning, by each fire device of the plurality of fire devices, to the cluster via a predetermined network key included in each fire device of the plurality of fire devices.

20. The method of claim 15, wherein causing the activation of the at least one fire device includes activating at least one of:
a visual alarm; and
an audible alarm.
